(19) United States
(12) Patent Application Publication
(10) Pub. No.: US 2014/0091727 A1
(43) Pub. Date: Apr. 3, 2014

(54) Off Peak Powered Lighting System for Offices and Buildings

(71) Applicant: Joel C. Westermarck, Lauderhill, FL (US)

(72) Inventor: Joel C. Westermarck, Lauderhill, FL (US)

(21) Appl. No.: 13/644,053

(22) Filed: Oct. 3, 2012

(51) Int. Cl. H05B 37/02

(52) U.S. Cl. 315/210

(57) ABSTRACT

The off-peak powered lighting system provides light to offices, buildings and structures via banks of LED light fixtures. The off-peak system is electrically coupled to battery power source during peak power cycles and then is coupled to an electrical power grid during off-peak cycles. The banks of LED lights, in the offices, buildings and structures, include LED lighting fixtures, each with a multiplicity of LEDs. The LED banks are controlled by a plurality of control switches. A power cycle switch coupled intermediate the power grid and the control switches. controllably couples the grid to the control switches or couples the battery source to the control switches based upon a control command, generated by a controller which creates off-peak and peak control commands. The controller is either a timer, a programmable time of day, or a remotely controllable element subjected to grid-originated peak commands.

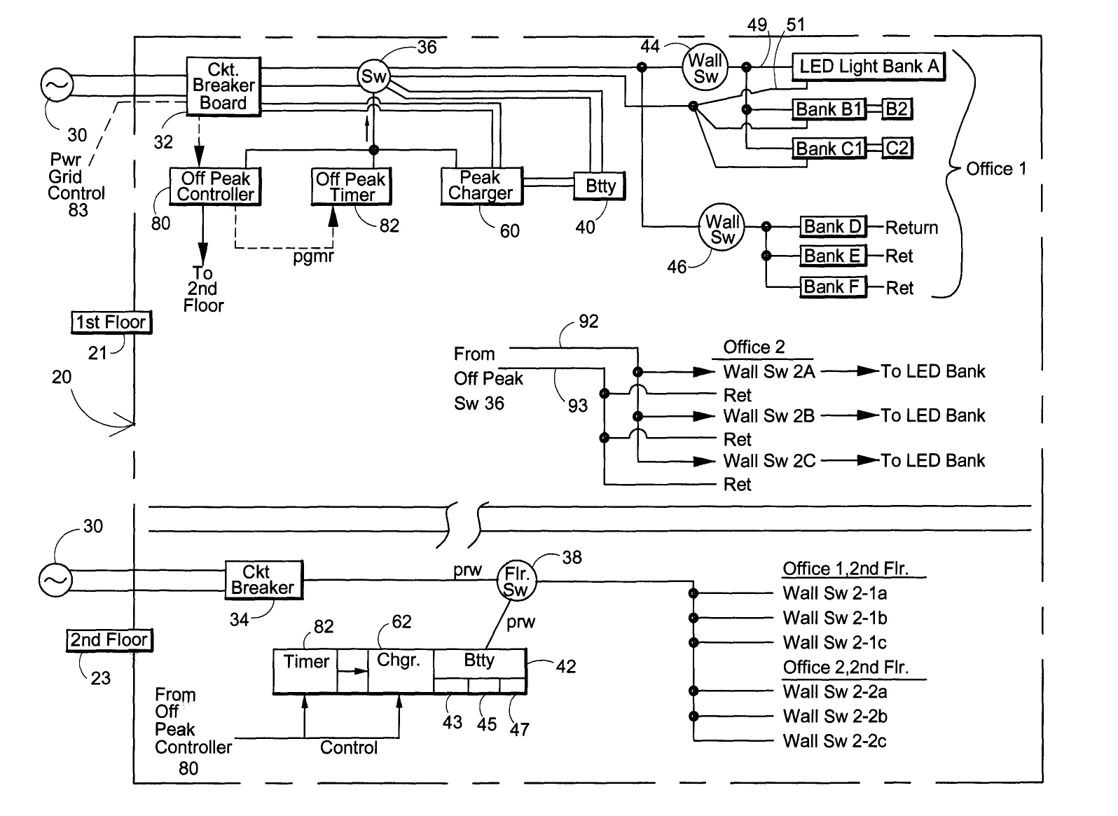

The present invention relates to an off peak powered lighting system that provides light to offices, buildings and structures. These offices, buildings and structures are typically powered from an electrical power grid which is operated by a public utility. The contents of U.S. patent application Ser. No. 13/164,406, filed Jun. 20, 2011, is incorporated herein by reference thereto.

### BACKGROUND OF THE INVENTION

Electrical power consumption in offices, buildings and structures, is sometimes based upon time of day and day of the week consumption periods. During heavy utilization of the electrical power grid, the utility company charges higher rates (kilowatts per power). These higher rate periods are called “peak power consumption cycles” as compared with time of day and day of the week billing rates wherein less power is consumed by the occupants and equipment in the offices, buildings and structures. These low consumption periods are called off-peak consumption cycles. Herein, a reference to “an office” refers to one or more of offices, buildings and/or structures.

U.S. Patent Publication No. 2012-0080944 to Recker discloses a grid shifting system for a lighting circuit. The power management system includes a grid shifting controller that provides control information to one or more electrical fixtures which is subject to power grid shifting. These electrical fixtures have wireless controls and the off/on grid control signals are generally generated by the control processor and the grid shifting controller. Wireless signals control the fixtures. U.S. Patent Publication 2012-0043889 to Recker also shows an off grid LED power failure lights. These power failure lights are controlled by wireless control systems. U.S. Pat. No. 4,894,764 to Meyer discloses a modular air conditioning (AC) unit having a power leveling system wherein batteries store energy during off peak power cycles and supply energy during peak power maintenance. U.S. Patent Publication No. 2011-0313603 to Laberteaux discloses a system and method for optimizing a use of a battery. U.S. Pat. No. 6,115,268 to Chang discloses a method and apparatus for supplying uninterrupted power. U.S. Patent Publication 2003-0061828 to Blevins discloses an air conditioner with a battery power source.

### OBJECTS OF THE INVENTION

It is an object of the present invention to provide an off peak powered lighting system which utilizes banks of LED lights which are controllably turn ON and provided with battery power during peak power consumption cycles and which are powered ON by the electrical power grid during off peak consumption cycles.

It is a further object of the present invention to provide a controller generating “off peak” control signals and “peak” control signals thereby affecting the switch over by a cycle switch between the utility company electrical power grid and the battery power supply. The battery power is applied to the LED light banks by the cycle switch during the “peak” power consumption cycle times.

### BRIEF DESCRIPTION OF THE DRAWINGS

Further objects and advantages of the present invention can be found in the detailed description of the preferred embodiments when taken in conjunction with the accompanying drawing in which:

The sole FIGURE illustrates an office, building or structure having a plurality of banks of LED lights, off peak controllers and a battery power supply system.

### SUMMARY OF THE INVENTION

The off-peak powered lighting system provides light to offices, buildings and structures via banks of LED light fixtures. The off-peak lighting system is electrically coupled to battery power source during peak power consumption time-based cycles and then is coupled to an electrical power grid during off-peak consumption cycles. A plurality of banks of LED lights, disposed in and about the offices, buildings and structures, consist of one or more LED lighting fixtures and each LED lighting fixture has a multiplicity of LEDs disposed in the LED fixture. The LED light banks are controlled by a plurality of control switches for activating and deactivating one or more LED light banks and corresponding LED fixtures. A power cycle switch is coupled intermediate the electrical power grid and the plurality of control switches. The cycle switch is adapted to controllably couple the electrical power grid to the plurality of control switches or to couple electrical power from the battery power source to the plurality of control switches based upon a control command. The battery source is charged by a charging system powered by said electrical power grid during off-peak cycles. A controller generates an off-peak control and a peak control command which are applied to the cycle switch such that, in the presence of the off-peak control command the cycle switch electrically couples the electrical power grid to the plurality of control switches enabling activation of the LED light banks. In the presence of the peak control command, the cycle switch electrically couples the battery power source to the plurality of control switches enabling activation of said LED light banks. The controller is either a timer, a remotely activated count down timer, a programmable day of the week and time of day timer, or a remotely controllable element subjected to grid-originated peak commands from the electrical power grid.

### DETAILED DESCRIPTION OF THE PREFERRED EMBODIMENTS

The present invention relates to an off peak powered lighting system which provides lights to offices, buildings and structures. The lighting system utilizes LED lighting fixtures having a multiplicity of LEDs and these fixtures are grouped as banks of LED lights in offices, buildings or structures. The LED fixtures maybe on structures such as night lights for construction or parking lots or on signs. Conventionally powered lighting systems in buildings and offices and structures, powered by the electrical power grid, are known by persons with ordinary skill in the art. Although the following discussion is focused on an office or a series of offices in a building, the lighting system components can be adapted to any structure, light pole, sign or other item with an illumination system.

The sole FIGURE provides an example of office building 20 having first floor 21 and second floor 23. It should be noted that rather than having LED light fixtures disposed in an office, those same LED light fixtures could be disposed on a pole or a sign and therefore could be equally applied to a light pole structure or a signage structure. Office building 20 is a structure.

Electrical power is supplied by electrical power grid 30 to office building 20. The second floor 23 of office building 20 is also supplied with power from the electrical power grid 30. The electrical power grid maintained and operated by the utility company supplies power to a circuit breaker panel or board 32, 34. In the illustrated embodiment, the breaker panels are disposed in the first and second floor respectively. Alternatively, a single panel may be used for the entire building. In a structure, the panel 32 may be a singular circuit breaker (for example, a light pole may have a single beaker or fuse. Rather than a circuit breaker, a fuse panel may be used. The circuit breaker panels 32, 34 are electrically coupled to a cycle switch 36, 38.

In summary, cycle switch 36, 38 switches the power from electrical grid 30, upon application of the proper control signal, to power from battery 40, 42. The output from cycle switch 36, 38 is applied to one or more control switches 44, 46 and, in second floor 23, to control wall switches 2-1A, 2-1B, 2-1C and, in office 2, second floor, control wall switch 2-2A, wall switch 2-2B and wall switch 2-2C.

Returning to first floor 21, wall switch 44 controls a plurality of banks of LED lights, bank A, bank B and bank C. Each of these banks of LED lights has one or more LED lighting fixtures. Therefore, in connection with bank B1, bank B1 illustrates LED lighting fixture B1 and B2 illustrates LED lighting fixture B2. Light banks A, B1, B2, C1 and C2 are all controlled by control switch 44.

Each LED lighting fixture includes a multiplicity of LEDs disposed in the LED fixture unit. Pending patent application Ser. No. 13/164,406 entitled “LED Light Tube and Replacement Method” discloses one type of LED fixture with a multiplicity of LED lights therein. The contents of that patent application is incorporated herein by reference thereto. These LED fixtures use extremely low levels of power as discussed in the referenced patent application.

Each LED light bank includes a corresponding electrical terminal set. Therefore, in connection with LED light bank A, the electrical power terminal set is illustrated by lines 49, 51. In connection with LED banks D, E and F, the return line is symbolically illustrated (abbreviated “RET”). Sometimes, only the power lines are shown running from control wall switch 46 to LED light banks D, E and F. The return line is shown immediately beneath control switch 44 which, with respect to office number 1 in first floor 21, is control wall switch 44.

As discussed earlier, during “off peak” consumption cycles, the banks of LED lights are powered by electrical power grid 30 since cycle switch 36 couples electrical power grid 30 to the LED light banks via the appropriate wall switch 44, 46. If the control wall switches are OFF, the associated LED banks are not powered up. During “peak” power consumption time cycles, cycle switch 36 supplies power from battery 40 to wall switches 44, 46.

Battery 40, 42 may be a plurality of batteries as noted in battery 42 as units 43, 45, 47. In either case, battery 40, 42 is charged via peak charger 60, 62. In the illustrated embodiment, charger 60, 62 is supplied with power from circuit breaker panel 32, 34. The peak charger 60, 62 is operable to charge battery 40, 42 during off peak consumption cycle as controlled by the negative or NOT control signal applied on line 71. The off peak controller 80 is either a timer, a remotely activated count down timer, a programmable day of the week and time of day timer or a remotely controllable element effected by grid-oriented commands from electrical power grid 30.

As a simple timer, off peak controller 80 issues an off peak SWITCH OVER control command to cycle switch 36 indicating that the power from grid 30 should be decoupled and the battery source power from battery 40, 42 should be coupled ON thereby switching the power from the electrical power grid 30 to the battery source 40 via cycle switch 36. Alternatively, an off peak timer 82 could be utilized. Off peak timer 82 could be programmed based upon commands from off peak controller 80. For example, the electrical power grid 30 could apply a power grid control signal 83 (see dashed lines) super imposed on the power lines, or otherwise delivered through the internet or telecommunication lines to off peak controller 80. This is a trigger command. Off peak controller 80 would modify the power grid originated peak command and trigger the off peak timer to go ON (or OFF if needed), for example, between 8 am and 6 pm Monday through Friday. The trigger could go HIGH at 8 AM Monday, 8 AM Tuesday, etc. The off peak timer would then be activated at 8:00 AM which causes cycle switch 36 to disconnect power grid 30 from the lights and connect battery source 40 to the wall control switches 44, 46. In this situation, off peak timer 82 counts down from 8:00 AM to 6:00 PM, a programmable ten (10) hour countdown (different count down periods can be used). At the end of the count down, the peak timer switches over the cycle switch to apply grid power and turn OFF the battery power. At 6:00 PM, off peak timer 82 would provide another control signal to cycle switch 36 which would turn OFF battery source 40 and turn ON electrical power grid 30 and apply the power grid supply to wall switches 44, 46.

With respect to office 2 in first floor 21, the cycle switch 36 output is applied to lines 92, 93 and those power lines are applied to wall switch 2A, which leads to one or more banks of LEDs, and wall switch 2B and wall switch 2C. In this manner, a single cycle switch and battery source is used on each floor.

With respect to second floor 23, the circuit breaker panel 34 may be directly connected to electrical grid 30 or the circuit breaker panel could be connected to circuit breaker panel 32. Also, it is known that a single circuit breaker panel could be provided for the entire building based upon the size and power consumption of the building. The operation of off peak timer 82 and peak charger 62 and battery 42 is substantially identical to the operation and charging and use of battery 40 described above in connection with first floor 21.

It should be noted that each office may have its own cycle switch and battery power, or the entire building may have a single cycle switch and battery power.

The claims appended hereto are meant to cover modifications and changes within the scope and spirit of the present invention.

What is claimed is:

1. An off-peak powered lighting system which provides light to offices, buildings and structures, the off-peak lighting system being electrically coupled to an electrical power grid having peak power consumption time-based cycles and off-peak consumption cycles, the off-peak lighting system disposed in or on said offices, buildings and structures and comprising:
a plurality of banks of LED lights, each LED light bank having one or more LED lighting fixtures and each LED lighting fixture having a multiplicity of LEDs disposed in the LED fixture, the plurality of LED light banks providing light in and about said offices, buildings and structures, and each LED light bank having a corresponding electrical power terminal set;
said plurality of LED light banks being disposed in and about said offices, buildings and structures;
a plurality of control switches for activating and deactivating one or more LED light banks and corresponding LED fixtures, said control switches coupled to the corresponding electrical power terminal sets for the controlled LED light banks;
a cycle switch coupled intermediate said electrical power grid and said plurality of control switches, said cycle switch adapted to controllably couple said electrical power grid to said plurality of control switches or to couple electrical power from a battery power source to said plurality of control switches based upon a control command;
one or more batteries for supplying power to said plurality of LED light banks as said battery power source, said one or more batteries coupled to said cycle switch;
a charging system powered by said electrical power grid and adapted to charge said battery power source;
a controller generating an off-peak control and a peak control command which are applied to said cycle switch such that, in the presence of said off-peak control command said cycle switch electrically couples said electrical power grid to said plurality of control switches enabling activation of said LED light banks, and in the presence of said peak control command said cycle switch electrically couples said battery power source to said plurality of control switches enabling activation of said LED light banks, said controller being either a timer, a remotely activated count down timer, a programmable day of the week and time of day timer, or a remotely controllable element subjected to grid-originated peak commands from said electrical power grid.

2. An off-peak powered lighting system as claimed in claim 1 wherein said charging system is controllably coupled to said electrical power grid in the absence of said off-peak control command.

3. An off-peak powered lighting system as claimed in claim 1 wherein said offices, buildings and structures are grouped into floors or substructures, and the system includes, for each floor or substructure, a corresponding cycle switch, battery power source and charging system, said corresponding cycle switch being coupled to LED light banks disposed in the respective floor or substructure and the associated respective plurality of control switches.
